(19) United States
(12) Patent Application Publication
(10) Pub. No.: US 2023/0306189 A1
(43) Pub. Date: Sep. 28, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Toru MORITA, Kanagawa (JP)

(73) Assignee: FUJIFILM Business Innovation Corp., Tokyo (JP)

(21) Appl. No.: 17/885,530

(22) Filed: Aug. 10, 2022

(30) Foreign Application Priority Data
Mar. 25, 2022 (JP) 2022-049669

(51) Int. Cl. G06F 40/151; G06F 40/134

(52) U.S. Cl. CPC G06F 40/151; G06F 40/134

(57) ABSTRACT

An information processing apparatus includes a processor configured to: acquire information from an external link destination inserted into a document in a document format that can be viewed without depending on a software environment; in a case where the acquired information is a web page, convert the web page into a file in the document format; and store the file obtained from the external link destination in an offline environment in association with the document.

### CROSS-REFERENCE TO RELATED APPLICATIONS

This application is based on and claims priority under 35 USC 119 from Japanese Patent Application No. 2022-049669 filed Mar. 25, 2022.

### BACKGROUND

### (i) Technical Field

The present invention relates to an information processing apparatus, a non-transitory computer readable medium storing a program, and an information processing method.

### (ii) Related Art

For example, an office application of Microsoft Corporation has a function of setting a link destination to text in a generated document. The link destination may be set to a reference destination in an identical document or an address to a web page.

Incidentally, in a case where a document is transmitted by e-mail or the like, the document may be converted into a file format that can be viewed without special software, for example, a Portable Document Format (PDF) file, and then attached. Consequently, the document can be viewed even in a case where an application that has created the document is not installed on a personal computer (PC) used by a recipient of the document that is a transmission destination.

### SUMMARY

However, in a case where an external web page or the like that can be referenced only in an online environment is specified as a link destination inserted in a document, and an information processing apparatus that refers to the document cannot be connected to an online environment, the document being a document in a document format that can be viewed without depending on a software environment, information obtained from the link destination cannot be referred to.

Aspects of non-limiting embodiments of the present disclosure relate to an image processing apparatus, a non-transitory computer readable medium storing a program, and an image processing method capable of referring to information obtained from an external link destination inserted in a document even in an offline environment.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing apparatus including a processor configured to: acquire information from an external link destination inserted into a document in a document format that is viewable without depending on a software environment; in a case where the acquired information is a web page, convert the web page into a file in the document format; and store the file obtained from the external link destination in an offline environment in association with the document.

### BRIEF DESCRIPTION OF THE DRAWINGS

Exemplary embodiment(s) of the present invention will be described in detail based on the following figures, wherein:

FIG. 1 is a diagram showing an overall configuration of a network system and a block configuration of a user terminal according to the present exemplary embodiment;

FIG. 2 is a flowchart showing a file conversion process according to the present exemplary embodiment;

FIG. 3 is a conceptual diagram showing details of a file conversion process to be performed in a case where a file acquired from an external link destination does not match attachment conditions in the present exemplary embodiment;

FIG. 4 is a diagram showing an example of setting an in-document link in the present exemplary embodiment;

FIG. 5 is a conceptual diagram showing details of a file conversion process to be performed in a case where a file acquired from an external link destination matches the attachment conditions in the present exemplary embodiment;

FIG. 6 is a conceptual diagram showing details of a file conversion process to be performed in a case where external link destinations are hierarchized in the present exemplary embodiment;

FIG. 7 is a diagram showing a display example of text having a different display form depending on a link destination in the present exemplary embodiment;

FIG. 8 is a diagram showing a display example in a case of displaying different tooltips depending on a link destination in the present exemplary embodiment; and

FIG. 9 is a diagram showing a display example of a mouse having a different display form depending on a link destination in the present exemplary embodiment.

### DETAILED DESCRIPTION

Hereinafter, exemplary embodiments of the present invention will be described with reference to the drawings.

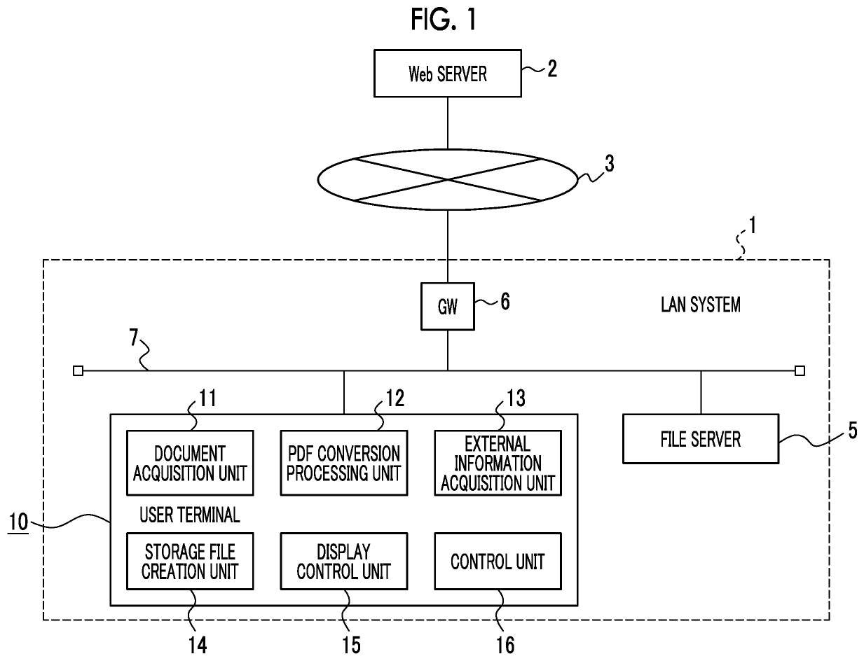

FIG. 1 is a diagram showing an overall configuration of a network system and a block configuration of a user terminal in the present exemplary embodiment. FIG. 1 shows a network system in which a local area network (LAN) system 1 and a web server 2 are connected via the Internet 3.

The LAN system 1 is, for example, a local system constructed in one office of a company, and is constructed by a user terminal 10 used by an employee or the like (hereinafter, a “user”), a file server 5 installed as means for storing a file used by the user, and a gateway (GW) 6 connecting the LAN system 1 to the Internet 3, which are connected to a LAN 7. A plurality of user terminals 10 may be connected to the LAN 7, but since each of the user terminals has a processing function that will be described later, FIG. 1 shows only one user terminal 10 as a representative.

The web server 2 holds various types of information provided to the user terminal 10 via the Internet 3. The web server 2 provides information by allowing a user to view a web page or download a file such as a download file. Although a plurality of web servers 2 are connected to the Internet 3, FIG. 1 shows only one web server 2 as a representative.

FIG. 1 shows a system configuration in which the LAN system 1 is connected to the Internet 3. That is, since the user terminal 10 included in the LAN system 1 is connected to the Internet 3 via the gateway 6 and can access the web server 2, the user terminal 10 is provided with a place for an online environment. Here, the “online environment” refers to an environment in which the Internet 3 can be connected. On the other hand, in a case where the gateway 6 is not connected to the Internet 3, the user terminal 10 cannot be connected to the Internet 3, so that the user terminal 10 is provided with a place for an offline environment. Here, the “offline environment” refers to an environment in which the Internet 3 cannot be connected. In the present exemplary embodiment, the online environment and the offline environment are used as contradictory terms. The user terminal 10 can be connected to the file server 5 via the LAN 7 even in a case where the user terminal 10 is placed in an offline environment.

The user terminal 10 in the present exemplary embodiment is provided as an information processing apparatus according to an exemplary embodiment of the present invention. The user terminal 10 can be implemented by, for example, a general-purpose PC or the like. That is, the user terminal 10 is configured as a hardware configuration by connecting a CPU, a ROM, a RAM, and a hard disk drive (HDD) as storage means, a user interface, and a network interface as communication means connected to the LAN 7 in a wired or wireless manner, to an internal bus. The user interface has input means such as a mouse and a keyboard and display means such as a display. Alternatively, the user interface may be configured with a touch panel or the like that also serves as input means and display means.

The user terminal 10 has a document acquisition unit 11, a PDF conversion processing unit 12, an external information acquisition unit 13, a storage file creation unit 14, a display control unit 15, and a control unit 16. Constituents not used in the description of the present exemplary embodiment are not illustrated in the drawings.

The document acquisition unit 11 acquires a document to be converted into a PDF file. In the present exemplary embodiment, the “document” is an electronic document and is synonymous with a document file. The document to be converted into a PDF file is a document in which a hyperlink can be set in the document, and is, for example, a document created by an office application of Microsoft Corporation.

The “hyperlink” that is also referred to simply as a “link” is reference information to other information resources embedded in an information resource such as a document, and is defined as an element in a document such as text or an image in which such a reference is set. In general, inserting a link in a document may be expressed as “setting a link” or “creating a link”. In the following description, inserting a link is inserted or setting a link refers to an identical operation. The “link destination” is a storage location of information designated by a Uniform Resource Locator (URL) or the like in the hyperlink. The link destination may also indicate a file such as a “direct link”.

The link destination is usually another location in the document or a storage location of information in the web server 2. In the present exemplary embodiment, a case where an information acquisition destination is the latter, that is, the web server 2 accessible via the Internet 3 will be particularly referred to as an “external link destination”. A “link” is roughly classified into an “internal link” and an “external link”. The “internal link” is defined as a link between pages within a site. In the present exemplary embodiment, the LAN system 1 corresponds to the above site. On the other hand, the “external link” is defined as a link other than the internal link. The “external link” in the present exemplary embodiment includes a link that for connection to an external site, that is, another site (the above web server 2) outside the LAN system 1, and a link, which is generally called a “direct link”, for direct connection to a resource (this resource is stored in the web server 2) other than a page (HyperText Markup Language (HTML)) such as an image file.

Returning to FIG. 1, the PDF conversion processing unit 12 converts a processing target file into a PDF file in response to an instruction. “Conversion into PDF file” will also be referred to as “PDF conversion”. The PDF file is an example of a document in a document format that can be viewed without depending on a software environment. The external information acquisition unit 13 acquires information as external information from a designated external link destination. The storage file creation unit 14 creates a file for storing information such as a document in an offline environment. The display control unit 15 controls display on a user interface such as a display. The control unit 16 realizes a characteristic function in the present exemplary embodiment in cooperation with the above constituents 11 to 15.

Each of the constituents 11 to 16 in the user terminal 10 is realized through a cooperative operation of a computer forming the user terminal 10 and a program running on a CPU mounted on the computer.

The program used in the present exemplary embodiment may be provided not only by communication means but also by being stored in a computer readable recording medium such as a CD-ROM or a USB memory. Programs provided by communication means or a recording medium are installed in a computer, and various processes are realized by a CPU of the computer sequentially executing the programs.

In the present exemplary embodiment, the above constituents 11 to 16 are shown as the functions of the user terminal 10, but these functions may be realized by different programs. Alternatively, the functions may be realized by using a function of one application, or may be realized by linking a plurality of applications. The applications include, for example, various types of software that handles PDF of Adobe System, and DocuWorks (registered trademark) of Fuji Xerox Business Innovation.

In a case where a user using the user terminal 10 sends a document to another person by e-mail or the like, for example, the document may be converted into a PDF file such that the other person (that is, a recipient of the document) can view the document without special software. Since the link setting is not deleted even in a case where the document is converted into a PDF file, a viewer (a user or a recipient) of the PDF file can acquire information from an external link destination designated in the PDF file in a case where the PDF file is referred to in an online environment. However, in the offline environment, even in a case where a viewer of the PDF file selects an external link, information at an external link destination cannot be referred to.

Therefore, in the present exemplary embodiment, when the user terminal 10 is operating in an online environment, information is acquired in advance from an external link destination, and a document is converted into PDF such that the document is stored in an offline environment in association with a created PDF file. Therefore, the information at the external link destination can be referred to even in a state in which the user terminal 10 is placed in an offline environment at the time of referring to the PDF file.

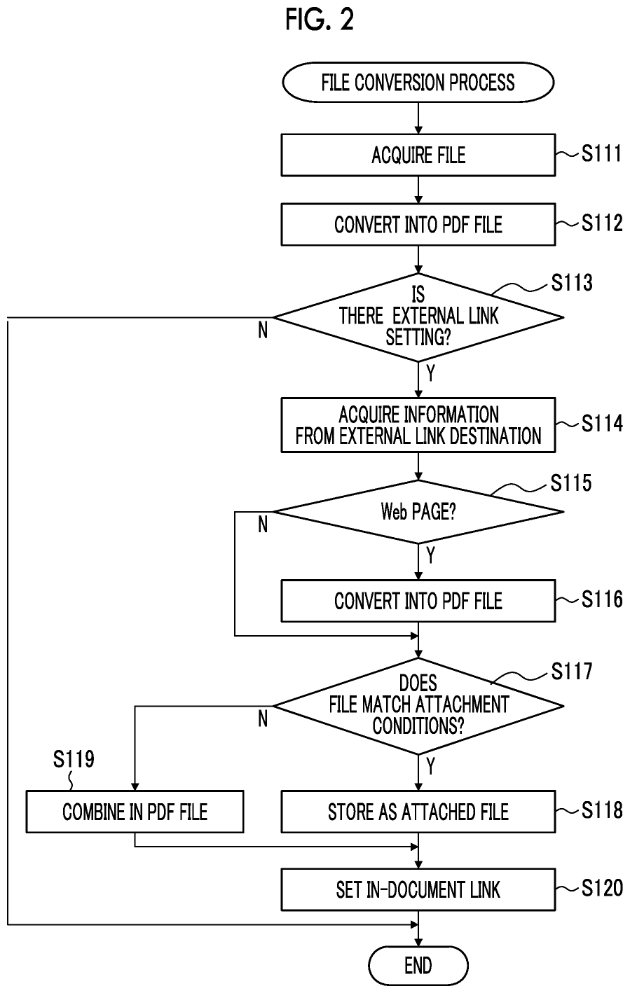

Hereinafter, a file conversion process of converting a document file into a PDF file in the present exemplary embodiment will be described with reference to the flowchart of FIG. 2. As described above, the present exemplary embodiment is characterized in that information obtained from an external link destination can be referred to even in an offline environment, and information can be acquired from an internal link destination that can be accessed even in an offline environment. Therefore, in the following description, a case where an external link destination is designated in a document will be focused on.

In a case where the document acquisition unit 11 acquires a document file designated by a user (step S111), the PDF conversion processing unit 12 converts the document file into a PDF file (step S112). As this file conversion function, a function that has existed before may be used.

Subsequently, the control unit 16 analyzes the PDF file to check whether or not an external link is set in the PDF file. The fact that the external link is set means that a storage destination of information attached to text or an image in the PDF file is the inside of the web server 2 accessed via the Internet 3. In a case where a plurality of external links are set in the PDF file, processes described below may be repeatedly performed on each of the external links. Therefore, one of the set external links will be focused on here.

In a case where no external link is set in the PDF file (N in step S113), this process is ended. In this case, the PDF file is stored in a predetermined storage location of the file server 5. As described above, since the focus is on the external link here, in a case where only an internal link is set, this process is ended.

In a case where an external link is set in the PDF file (Y in step S113), the external information acquisition unit 13 acquires information from the external link destination (step S114). The information acquired by the external information acquisition unit 13 may be roughly classified into information written on a web page stored in a storage location designated by the external link (more specifically, a file written in a markup language such as HTML for displaying the web page) and files disclosed in) and a file such as a download file or a compressed file.

Here, in a case where the acquired information is a web page (Y in step S115), the PDF conversion processing unit 12 converts the web page into a PDF file. More specifically, the web page is generated as a PDF file by performing format conversion of an HTML file or the like (step S116). In a case where the acquired information is not a web page but a file (N in step S115), the control unit 16 proceeds to step S117 without converting the acquired information into a PDF file.

In the following description, unless otherwise specified, a PDF file converted from a web page will be described.

The present exemplary embodiment is characterized in that a file obtained from an external link destination is associated with a PDF file 21 and stored in an offline environment, that is, in the LAN system 1. The “file obtained from the external link destination” corresponds to the PDF file created in step S116 and a file directly acquired from the web server 2, such as the download file, but here, the PDF file created in step S116 corresponds to the file obtained from the external link destination.

Subsequently, the control unit 16 determines whether or not the file acquired from the external link destination matches predetermined attachment conditions. Specific details of the attachment conditions will be described later, and here, a case where the file does not match the attachment conditions will be described first.

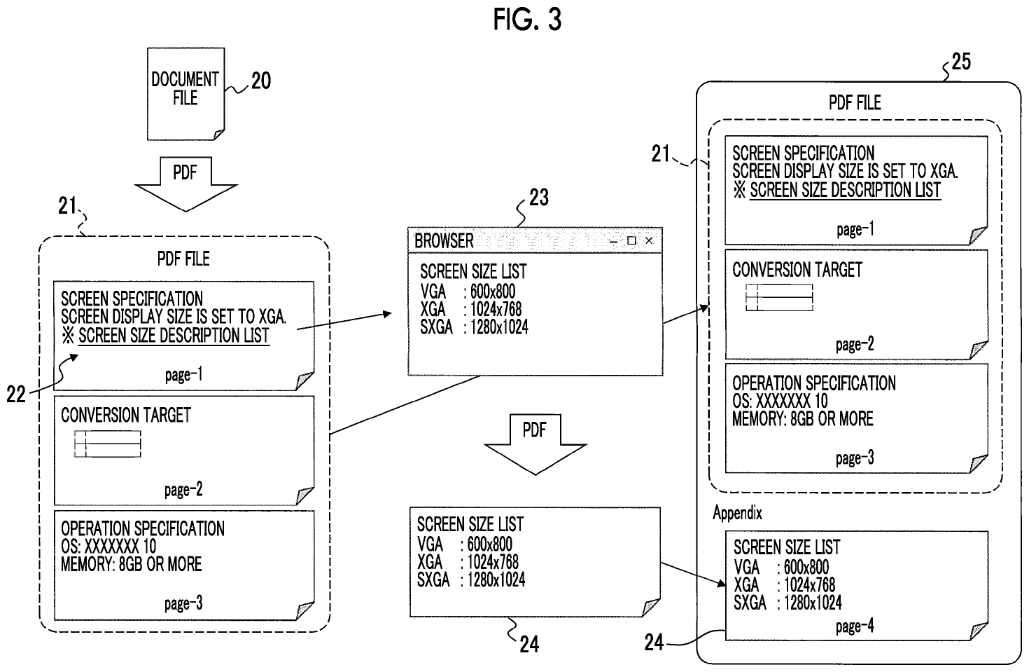

FIG. 3 is a conceptual diagram showing details of a file conversion process to be performed in a case where a file acquired from an external link destination does not match attachment conditions. In FIG. 3, a document file 20 is the file acquired in step S111. A PDF file 21 is a file created by performing format conversion of the document file 20 in step S112. As shown in FIG. 3, the PDF file 21 includes text (hereinafter, also referred to as an “external link”) 22 in which an external link is designated. A web page 23 is a web page displayed in a case where the external link 22 is selected. A PDF file 24 is a file created by performing format conversion of the web page 23, that is, the HTML file in step S116.

In a case where the file acquired from the external link destination does not match the predetermined attachment conditions (N in step S117), the storage file creation unit 14 combines the PDF file 24 as an appendix in the PDF file 21 to create a PDF file 25 to be stored (step S119). The “combination” in the present exemplary embodiment means that a plurality of files are integrally formed, that is, one file is generated. In the present exemplary embodiment, the PDF file 24 is added to the PDF file 21 and combined at the end of the document, but a location in a combined document is not necessarily limited to this. For example, a combined document may be inserted immediately after the external link 22.

According to the present exemplary embodiment, since the information of the web page 23 obtained from the external link destination is converted into PDF and combined with the original PDF file 21 to be stored, the information of the web page 23 can be referred to even in a case where the user terminal 10 is operating in an online environment.

The storage file creation unit 14 sets an in-document link between the PDF file 21 and the PDF file 24 in the PDF file 25 for storage (step S120).

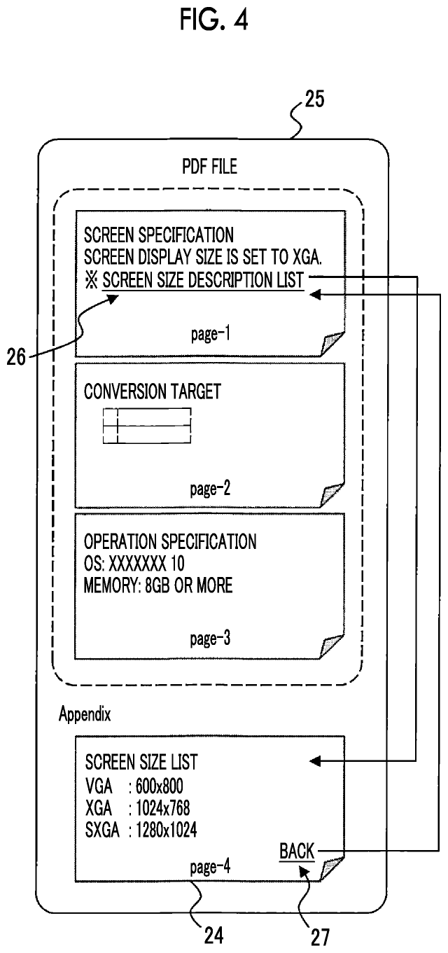

FIG. 4 is a diagram showing an example of setting an in-document link in the present exemplary embodiment, and shows only the PDF file 25 shown in FIG. 3. As shown in FIG. 4, in the PDF file 21, the external link is set to the text 22, but in the PDF file 25 for storage, an in-document link to the combined PDF file 24 is set to the text 26. Therefore, in a case where the user clicks the text 26, the PDF file 24 is displayed. However, as described above, the PDF file 24 has information content identical to information content of the web page 23 that is a creation source, and is thus identical to displaying the web page 23 by the external link 22 of the PDF file 21 being selected.

On the other hand, in the PDF file 24, the in-document link for returning the display to the insertion position of the text 26 is set to text “back” 27. Therefore, in a case where the user clicks the text 27, the display control unit 15 returns the display to the original display position where the text 26 has been displayed.

In the present exemplary embodiment, the PDF file 21 and the PDF file 24 can be exchanged with each other by setting in-document links (also referred to as “mutual links”) that can be exchanged with each other.

The PDF file 25 for storage is stored in any place in an offline environment. In the present exemplary embodiment, the file is stored in the file server 5, but the present exemplary embodiment is not limited to this, and the file may be stored in the user terminal 10 that has created the PDF file 25.

Here, specific details of the predetermined attachment conditions will be described.

As described above, in a case where the PDF file 24 is combined with the PDF file 21, the information of the original document and the information obtained from the external link destination can be integrally created, and thus it can be said that file management becomes simple. However, in a case where the PDF file 24 to be combined has a large capacity, a capacity of the PDF file 25 for storage also increases, which may make the management and viewing of the PDF file 25 inconvenient. Therefore, as a predetermined attachment condition, a case is set in which the number of pages of the PDF file 24 associated with the PDF file 21 is equal to or more than a threshold value, that is, equal to or greater than a predetermined number of pages. In a case where the PDF file 24 matches this attachment condition, the PDF file 24 is attached without being combined with the PDF file 21, that is, stored in an offline environment separately from the PDF file 21.

As an “attachment” method, an attached file of the PDF file 21 may be used, or a portfolio function provided by an application of Adobe Systems Incorporated may be used. Here, the attached PDF file will be collectively referred to as an “attached file” and stored in a predetermined folder on the file server 5.

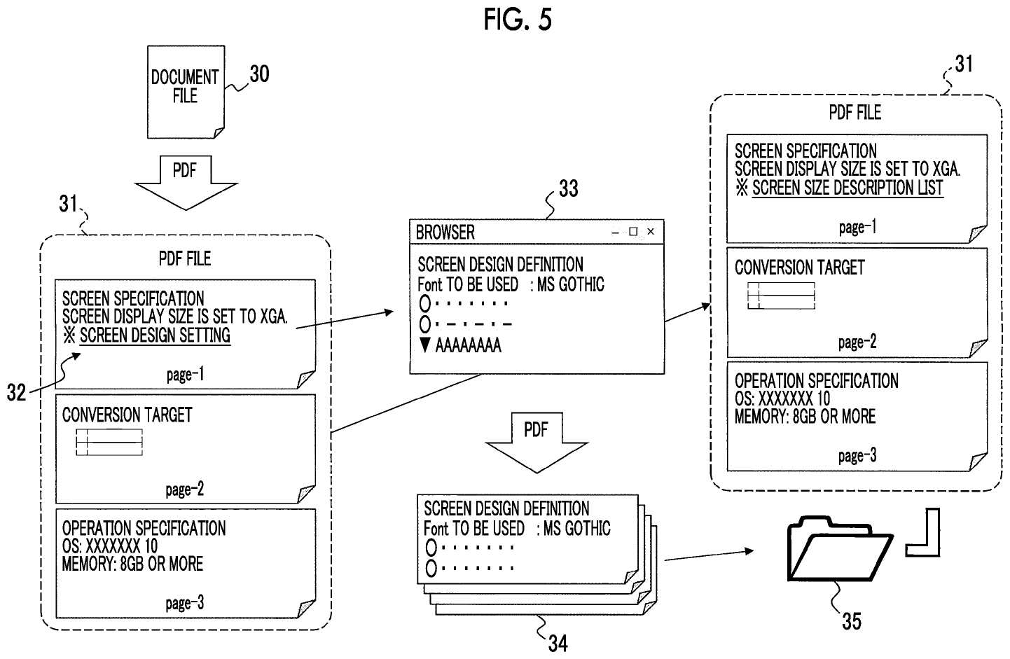

FIG. 5 is a conceptual diagram showing details of the file conversion process to be performed in a case where the file acquired from the external link destination matches the attachment conditions. In FIG. 5, the document file 30 shows the file acquired in step S111. A PDF file 31 is a file created by performing format conversion of a document file 30 in step S112. As shown in FIG. 5, the PDF file 31 includes an external link 32. A web page 33 is a web page displayed in a case where the external link 32 is selected. A PDF file 34 is a file created by performing format conversion of the web page 33, that is, the HTML file in step S116. The pieces of information 30 to 34 in FIG. 5 correspond to the pieces of information 20 to 24 in FIG. 3.

In a case where the file acquired from the external link destination matches the predetermined attachment conditions (Y in step S117), the storage file creation unit 14 stores the PDF file 34 as an attached file 35 of the PDF file 31 in an offline environment (step S118). A storage destination of the attached file 35 is predetermined as a predetermined folder in the file server 5, but the user may be inquired in a case of storing the file.

The predetermined attachment conditions are not necessarily limited to the above example. An attachment condition may be a case where an external link is a direct link and a file can be obtained directly from an external link destination. An attachment condition may be a case where, instead of performing automatic determination by setting a threshold value as described above, the user is inquired about a method of associating the PDF file 34 with the PDF file 31, and selects to attach and store the PDF file 34.

In the present exemplary embodiment, a document file acquired by the document acquisition unit 11 is converted into a PDF file, and then information is acquired from an external link destination. However, a timing of acquiring information is not necessarily limited to this. For example, since the document acquisition unit 11 can specify an external link destination by acquiring a document file and it is clear that a PDF file is created, information may be acquired from the external link destination before the PDF file is created. Information acquired from an external link destination may be converted into PDF before or after a document file acquired by the document acquisition unit 11 is converted into PDF.

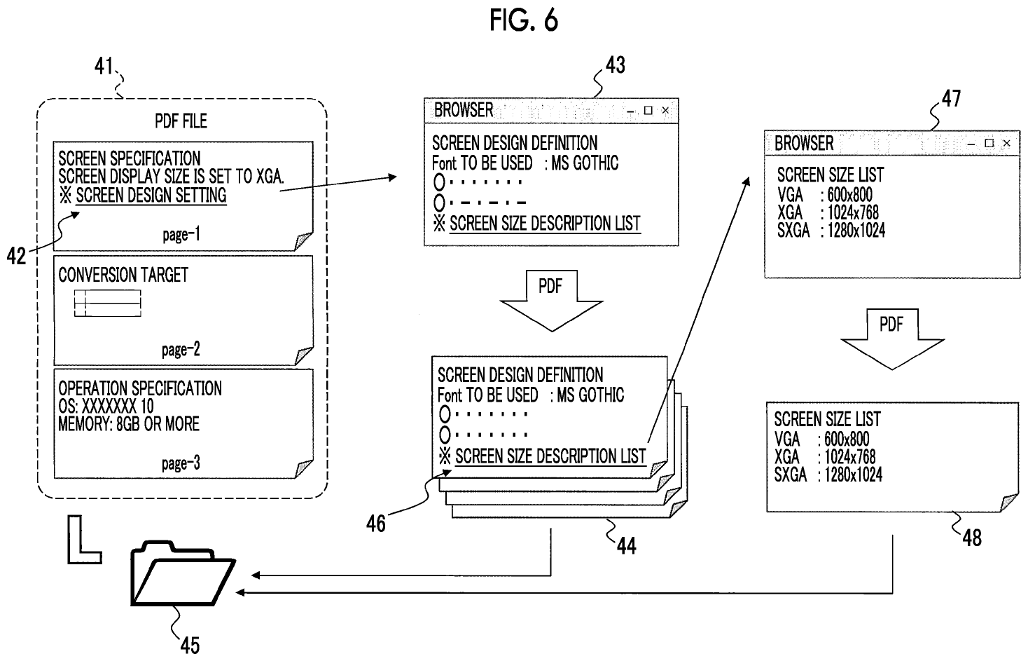

Incidentally, for example, in FIG. 5, an external link may be inserted into the PDF file 34 created from the web page 33 that is an external link destination of the PDF file 31. That is, the PDF file may be hierarchized by the link. In the present exemplary embodiment, since the link is set in the PDF file 34 corresponding to a child of the PDF file 31 corresponding to a parent, it is possible to deal with a case where a PDF file corresponding to a grandchild exists. Hereinafter, a case where external link destinations are hierarchized will be described with reference to FIG. 6. Basically, the processes in steps S113 to S120 may be performed in a nested state for each PDF file derived from the parent.

FIG. 6 is a conceptual diagram corresponding to FIGS. 3 and 5. In FIG. 6, a PDF file 41 is a file created in step S112. As shown in FIG. 6, the PDF file 41 includes an external link 42. A web page 43 is a web page corresponding to a first layer web page displayed in a case where an external link 42 is selected. A PDF file 44 is a file created by performing format conversion of the web page 43, that is, the HTML file in step S116. The PDF file 44 includes an external link 46. A web page 47 is a web page corresponding to a second layer web page displayed in a case where the external link 46 is selected. A PDF file 48 is a file created by performing format conversion of the web page 47, that is, the HTML file in step S116.

As described above, the PDF file 48 corresponding to the web page 47 is stored in an offline environment similarly to the PDF file 44 corresponding to the web page 43. In the example shown in FIG. 6, the PDF file 48 is included in an attached file 45 associated with the parent PDF file 41 and stored similarly to the PDF file 44 corresponding to the web page 43.

In FIG. 6, the web pages 43 and 47 up to the second layer are described as an example, but an external link may be further inserted into the second layer web page 47. Therefore, all web pages located in the lower layer derived from the parent PDF file 41 may be further converted into PDF and stored in an offline environment. However, in a case where the number of layers to be stored in an offline environment becomes huge, a file capacity to be stored may also become huge. Thus, a threshold value may be set for the number of layers to be added and stored in an offline environment, and a file obtained from a predetermined number of layers of web pages derived from the external link 42 inserted into the parent PDF file 41 may be stored in an offline environment.

The same may apply in a case where a file obtained from an external link destination does not match the attachment conditions. That is, in FIG. 3, a PDF file created from a web page below the second layer web page is combined as an appendix of the parent PDF file 21 similarly to the PDF file 24 created from the web page 23 of the first layer web page. However, in a case where PDF files below the child are uniformly combined with the parent PDF files 21 and 41 or included in the attached file 45, a hierarchical relationship cannot be ascertained. In this case, information for specifying a hierarchical relationship may be included in an appendix or an attached file, for example.

Each lower layer PDF file created from a web page of the second layer or lower may be stored in association with a PDF file of the immediately upper layer. A user may be allowed to select a storage location of information indicating the hierarchical relationship.

Incidentally, in a case where a description will be made with reference to FIG. 4, in the present exemplary embodiment, an in-document link is set in the text 26 in which the external link is set, instead of the external link. Consequently, the user terminal 10 can refer to information obtained from an external link destination even in an offline environment similarly to the case of an online environment. However, even in an online environment, that is, in a situation in which the web server 2 can be accessed, in the present exemplary embodiment, the information stored in an offline environment is referred to.

However, depending on the content of the information obtained from the web server 2, in a case where the web server 2 can be accessed, information may be acquired from the web server 2 each time. For example, for information that the web server 2 needs to keep the latest information at all times, for example, information such as manufacturer's notification information or a registration form for inquiries, the user wants to use the latest information. In consideration of such a case, in the present exemplary embodiment, designation of an external link originally set in a PDF file is not simply replaced with a link in a document, but is retained in an offline environment. The designation of the external link may be included in an attached file or an appendix, for example.

In a case where information can be acquired in an online environment when a link inserted into a PDF file is selected by a user, the control unit 16 determines whether an acquisition destination of the information is an online environment or an offline environment depending on characteristics of information obtained from an external link destination. The characteristics of the information obtained from the external link destination are, as exemplified above, information for which the web server 2 needs to keep the latest information at all times. For example, in a case where it is determined that it is better to acquire the information from the web server 2, the control unit 16 causes the external information acquisition unit 13 to acquire the information from the external link destination. The display control unit 15 presents the acquired information to the user by displaying the information on the display. On the other hand, in a case where it is determined that information stored in an offline environment is better, the display control unit 15 presents the information stored in the offline environment to the user by displaying the information on the display.

In the above description, the control unit 16 automatically performs determination depending on the characteristics of the information obtained from the external link destination, but in a state in which the information can be acquired from the web server 2, the user may be allowed to select an online environment or an offline environment as an information acquisition destination.

However, for example, in a case where a description will be made with reference to FIG. 4, even in a case where the user selects the identical text 26 in the PDF file 25, the PDF file 24 in the document may be displayed, or the information of the web server 2 may be displayed. The user cannot ascertain which information is displayed unless the user selects information to be displayed.

Therefore, in the present exemplary embodiment, it is possible to ascertain from which environment information is acquired before the user selects the text 26.

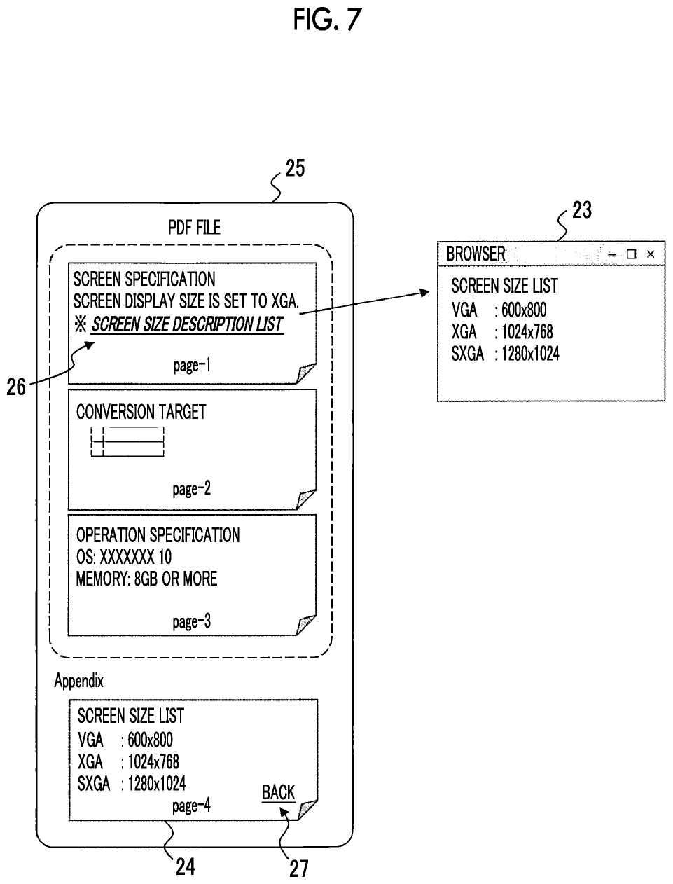

FIG. 7 is a diagram showing an example in which text is displayed in a different display form depending on a link destination in the present exemplary embodiment, and is a diagram corresponding to FIG. 4. FIG. 4 shows an example in which the PDF file 24 in the document is displayed by the user selecting the text 26. On the other hand, FIG. 7 shows an example in which the web page 23 is displayed by selecting the text 26. Here, as is clear from comparing the texts 26 in FIGS. 4 and 7, the text 26 in FIG. 7 linked to the web page 23 is displayed in bold and italic unlike the text 26 in FIG. 4 linked to the PDF file 24 in the document. That is, the control unit 16 checks whether or not the Internet 3 can be connected by inquiring, for example, the gateway 6. In a case where the Internet 3 can be connected and the web server 2 can be accessed, the display control unit 15 displays the text 26 in bold and italic as exemplified in FIG. 7 in response to an instruction from the control unit 16. In this case, the user needs to ascertain in advance a correspondence relationship between an information acquisition destination and a display form of the text 26.

As described above, the display control unit 15 performs display control such that it can be determined whether an information acquisition destination is an online environment or an offline environment.

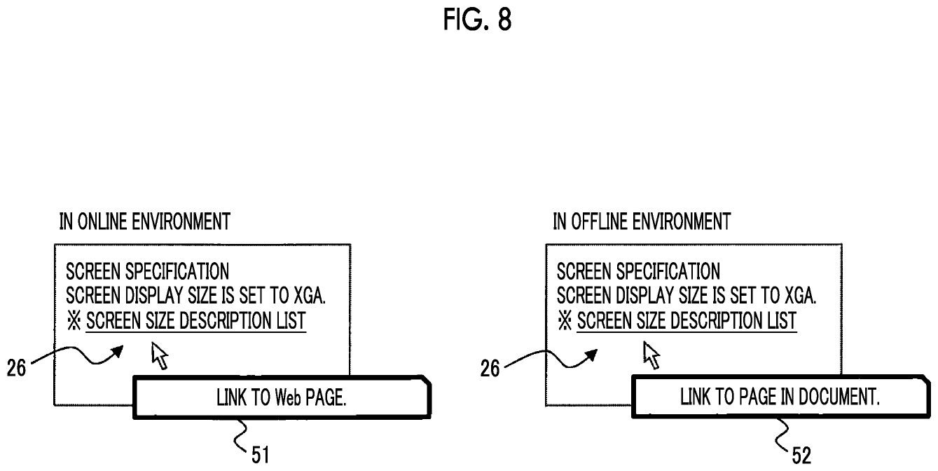

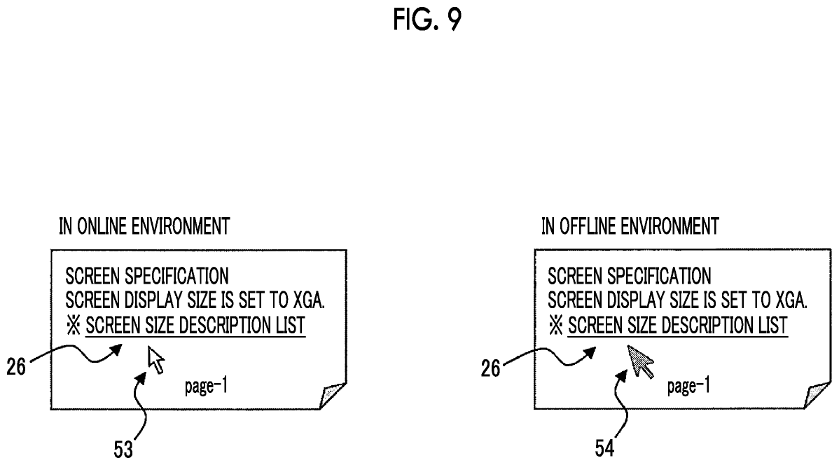

In FIGS. 4 and 7, a display form of the text 26 is made different, but is not necessarily limited to this. Other types of display control will be described with reference to FIGS. 8 and 9.

In a display example shown in FIG. 8, a page in which a link is set in a PDF file is extracted. The display control unit 15 does not change a display form of the text 26, but displays tooltips 51 and 52 in the vicinity of the text 26 as additional information to be displayed in a case where a mouse is over the text 26. Here, text information displayed in the tooltips 51 and 52 differs between an online environment and an offline environment. In other words, the text information displayed on the tooltips 51 and 52 differs depending on whether information is linked to the web page 23 or the PDF file 24 in the document. The content of the text information shown in FIG. 8 is an example and is not necessarily limited to this.

In a display example shown in FIG. 9, a page in which a link is set in a PDF file is extracted as in FIG. 8. The display control unit 15 does not change a display form of the text 26, but changes a display form of mice 53 and 54 when the mouse is over the text 26 depending on the current information acquisition destination, that is, between an online environment and an offline environment. In this case, the user needs to ascertain in advance a correspondence relationship between an information acquisition destination and a display form of the mice 53 and 54. A display form of the mice 53 and 54 shown in FIG. 9 is an example, and is not necessarily to be limited to this display form.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a processor configured to:
acquire information from an external link destination inserted into a document in a document format that is viewable without depending on a software environment;
in a case where the acquired information is a web page, convert the web page into a file in the document format; and
store the file obtained from the external link destination in an offline environment in association with the document.

2. The information processing apparatus according to claim 1, wherein the processor is configured to:
combine and store the file in the document.

3. The information processing apparatus according to claim 2, wherein the processor is configured to:
attach and store the file to and in the document without combining the file in a case where the file matches a predetermined attachment condition.

4. The information processing apparatus according to claim 3,
wherein the predetermined attachment condition is a case where the number of pages of the file is a predetermined number or more.

5. The information processing apparatus according to claim 3,
wherein the predetermined attachment condition is a case where a user selects to attach and store the file.

6. The information processing apparatus according to claim 2, wherein the processor is configured to:
summarize details of the file and then store the file.

7. The information processing apparatus according to claim 3, wherein the processor is configured to:
summarize details of the file and then store the file.

8. The information processing apparatus according to claim 2, wherein the processor is configured to:
set an in-document link between an insertion position of an external link in the document and the combined file.

9. The information processing apparatus according to claim 1, wherein the processor is configured to:
acquire information from the external link destination inserted into the web page in a case where the external link destination inserted into the document is a web page and an external link is inserted into the web page,
set the web page as a second layer web page, and convert the second layer web page into a file in the document format in a case where the web page is a first layer web page and information acquired from an external link destination inserted into the first layer web page is a web page, and
store a file obtained from the first layer web page in an offline environment.

10. The information processing apparatus according to claim 9, wherein the processor is configured to:
store a file obtained from a predetermined number of layers of web pages derived from an external link inserted into the document in the offline environment.

11. The information processing apparatus according to claim 1, wherein the processor is configured to:
store designation of an external link inserted into the document.

12. The information processing apparatus according to claim 11, wherein the processor is configured to:
determine whether an acquisition destination of the information is the online environment or the offline environment according to characteristics of the information obtained from the external link destination in a case where information is obtainable from an online environment when the external link inserted into the document is selected by a user.

13. The information processing apparatus according to claim 12, wherein the processor is configured to:
perform display control such that the acquisition destination of the information obtained from the external link destination selected by the user is discriminable.

14. A non-transitory computer readable medium storing a program causing a computer to realize:
a function of acquiring information from an external link destination inserted into a document in a document format that is viewable without depending on a software environment;
a function of, in a case where the acquired information is a web page, converting the web page into a file in the document format; and
a function of storing the file obtained from the external link destination in an offline environment in association with the document.

15. An information processing method comprising:
acquiring information from an external link destination inserted into a document in a document format that is viewable without depending on a software environment;
in a case where the acquired information is a web page, converting the web page into a file in the document format; and
storing the file obtained from the external link destination in an offline environment in association with the document.
